(19) United States
(12) Patent Application Publication
(10) Pub. No.: US 2026/0367870 A1
(43) Pub. Date: Nov. 19, 2026

(54) HYBRID RING GENERATORS

(71) Applicant: Siemens Industry Software Inc., Plano, TX (US)

(72) Inventors: Janusz Rajski, Wilsonville, OR (US); Jerzy Tyszer, Poznan (PL); Maciej Trawka, Posen (PL); Bartosz Wlodarczak, Swarzedz (PL)

(73) Assignee: Siemens Industry Software Inc., Plano, TX (US)

(21) Appl. No.: 19/478,307

(22) PCT Filed: Apr. 28, 2023
(86) PCT No.: PCT/US2023/020389

§ 371 Date: Oct. 24, 2025

(51) Int. Cl. G06F 7/58

(52) U.S. Cl. CPC G06F 7/584

(57) ABSTRACT

An n-bit hybrid ring generator-based system comprises: n state elements forming a ringlike structure and m feedback-enable devices, each of which is placed between two neighboring state elements. Numbers of feedback-enable devices placed on the top and bottom rows of the ring structure are equal or differ by one. None of the m feedback lines cross each other and the upward feedback lines and the downward feedback lines are placed alternatively with respective to each other. The ring structure implements a primitive polynomial of degree n. The n-bit hybrid ring generator-based system may be derived based on a primitiveness test. The n-bit hybrid ring generator-based system may be used to generate a reciprocal form or a dual form. The n-bit hybrid ring generator-based system may be a configurable hybrid ring generator, or a multiple-input signature register.

### FIELD OF THE DISCLOSED TECHNIQUES

The presently disclosed techniques relate to the field of circuit test, hardware security and trust, and communications. Various implementations of the disclosed techniques may be particularly useful for designing and using hybrid ring generator-based systems.

### BACKGROUND OF THE DISCLOSED TECHNIQUES

Ring generators are high performance linear feedback shift registers. Compared with conventional Fibonacci or Galois linear feedback shift registers (LFSRs), ring generators implementing the same characteristic (feedback) polynomials feature significantly reduced internal fan-outs, much shorter propagation paths, and simplified circuit layout and routing. Ring generators have been used as test data decompressors for deterministic circuit test, pseudorandom pattern generators for in-system test, and multiple-input test response compactors. In addition to circuit test, ring generators can also be employed in the areas of communications, digital broadcasting, data transmission, mobile telephony, security and cryptography, white noise generation, error detection and correction, data compression, and event counting. For example, ring generators can play several roles for hardware roots of trust: producing true random numbers, hashing proprietary data, and encrypting and decrypting test data streams.

In 2011, a new type of ring generators was proposed by L.-T. Wang et al. in both a paper titled “High-Speed Hybrid Ring Generator Design Providing Maximum-Length Sequences with Low Hardware Cost” (Technical Report, Computer Engineering Research Center, The University of Texas at Austin, referred to as Wang paper therein after) and a U.S. Pat. No. 8,949,299 (filed on Aug. 1, 2011 and granted on Feb. 3, 2015, referred to as '299 patent therein after). This new type of ring generators, referred to as hybrid ring generators, is derived by rearchitecting a certain type of conventional ring generators-only those whose characteristic polynomials can be rewritten as h(x)=x^{k}(x)+b(x)+1 or h(x)=xⁿ+x^{k}b(x)+b(x). The architecture transformation can reduce the number of XOR gates used for feedback nearly by half while still providing a maximum length sequence. The architecture constrained by the certain type of conventional ring generators, however, hinders practical applications. A new type of hybrid ring generators having flexible architecture and being able to create a new and enlarged implementation domain is highly desirable.

### BRIEF SUMMARY OF THE DISCLOSED TECHNIQUES

Various aspects of the disclosed technology relate to hybrid ring generator-based systems. In one aspect, there is an n-bit hybrid ring generator-based system, comprising: n state elements connected directly or indirectly to each other to form a ringlike structure in a schematic diagram, the ringlike structure having a top row and a bottom row, numbers of state elements in the n state elements placed on the top row and the bottom row being equal or differing by one; and m feedback-enable devices, m being greater than 2, each of the m feedback-enable devices being placed between two neighboring state elements in the n state elements and receiving signals directly or indirectly from one of the two neighboring state elements and a state element on a different row via a feedback line, respectively, numbers of feedback-enable devices placed on the top row and the bottom row being equal or differing by one, feedback lines associated with the feedback-enable devices on the top row and the bottom row being referred to as upward feedback lines and downward feedback lines, respectively, wherein none of the m feedback lines cross each other and the upward feedback lines and the downward feedback lines are placed alternatively with respective to each other, and wherein the ring structure implements a primitive polynomial of degree n.

The n state elements may be n flip-flops and the m feedback-enable devices may be m XOR gates.

The m feedback lines may be distributed in the ringlike structure approximately uniformly, approximately uniformly meaning that numbers of two groups of state elements on the top row or on the bottom row between any three neighboring feedback lines or between two neighboring feedback lines and their neighboring end of the ringlike structure are equal or differ by no more than two.

The n-bit hybrid ring generator-based system may further comprise: extra feedback-enable devices; storage devices; and logic devices, wherein the extra feedback-enable devices, the storage devices and the logic devices are configured to make the ring structure reconfigurable based on data bits stored in the storage devices, capable of implementing more than one primitive polynomial of degree n.

The n-bit hybrid ring generator-based system may further comprise: injection devices placed in the ring structure to form a multiple-input signature register.

The numbers n, m, positions of one or more of the m feedback-enable devices, or any combinations thereof may be determined based on a primitiveness test.

The ring structure may be used to derive a second ring structure implementing a reciprocal of the primitive polynomial of degree n. The ring structure may be used to derive a dual form of the ring structure.

In another aspect, there are one or more non-transitory computer-readable media storing computer-executable instructions for causing one or more processors to perform a method, the method comprising: creating the above circuit in a circuit design.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclosed techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1A illustrates an 18-bit Fibonacci linear feedback shift register and a corresponding primitive polynomial.

FIG. 1B illustrates an 18-bit hybrid linear feedback shift register derived from the 18-bit Fibonacci linear feedback shift register in FIG. 1A and its associated hybrid characteristic polynomial.

FIG. 2A illustrates an 8-bit ring generator and a corresponding primitive polynomial.

FIG. 2B illustrates such an 8-bit hybrid ring generator derived from the 8-bit ring generator in FIG. 2A and its associated hybrid characteristic polynomial.

FIG. 3A illustrates a 24-bit ring generator and a corresponding primitive polynomial.

FIG. 3B illustrates a 24-bit hybrid ring generator derived from the 24-bit ring generator in FIG. 3A and its associated hybrid characteristic polynomial.

FIG. 4 illustrates an example of an n-bit hybrid ring generator-based system that may be implemented according to various embodiments of the disclosed technology.

FIG. 5 illustrates a flowchart showing a process for generating a maximum-length hybrid ring generator-based system that may be implemented according to various examples of the disclosed technology.

FIG. 6 illustrates a 4-bit ring generator and a lookup table which are used to show how a primitiveness test operates.

FIG. 7 illustrates some maximum-length hybrid ring generators generated by using the the structural approach illustrated by the flowchart in FIG. 5.

FIG. 8A illustrates an example conventional 32-bit ring generator that implements a primitive polynomial corresponding to a 32-bit hybrid ring generator in FIG. 7.

FIG. 8B illustrates an example 32-bit hybrid ring generator and its hybrid characteristic polynomial corresponding to a 32-bit hybrid ring generator in FIG. 7.

FIG. 9A illustrates a 32-bit hybrid ring generator and its hybrid characteristic polynomial that is a reciprocal form of the hybrid characteristic polynomial in FIG. 8B.

FIG. 10 illustrates an example multiple-input signature register that may be implemented according to various embodiments of the disclosed technology.

FIG. 11 illustrates a table that provides the number of clock cycles τ necessary for the error to reach every flip-flop at least once for several multiple-input signature registers and different error injection sites.

FIG. 12 illustrates an example programmable hybrid ring generator that may be implemented according to various embodiments of the disclosed technology.

FIG. 13 illustrates the number of primitive polynomials that can be used in conjunction with hybrid ring generators.

FIG. 14 illustrates an example of a programmable computer system with which various embodiments of the disclosed technology may be employed.

### DETAILED DESCRIPTION OF THE DISCLOSED TECHNIQUES

Various aspects of the disclosed technology relate to hybrid ring generator-based systems. In the following description, numerous details are set forth for the purpose of explanation. However, one of ordinary skill in the art will realize that the disclosed technology may be practiced without the use of these specific details. In other instances, well-known features have not been described in detail to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “connect,” “place,” and “implement” to describe the disclosed method or the device function/structure. Such terms are high-level descriptions. The actual operations or functions/structures that correspond to these terms will vary depending on the particular implementation and are readily discernible by one of ordinary skill in the art.

As used in this disclosure, the singular forms “a,” “an,” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements not affecting the intended operation of the circuit.

Additionally, as used herein, the term “design” is intended to encompass data describing an entire integrated circuit device. This term also is intended to encompass a smaller group of data describing one or more components of an entire device such as a portion of an integrated circuit device nevertheless.

In 1988, L.-T. Wang and E. J. McCluskey showed in a paper titled “Hybrid designs generating maximum-length sequences” (IEEE Trans. Comput.-Aided Design Integr. Circuits Syst., vol. 7, no. 1, pp. 91-99, January 1988) that if a characteristic polynomial for a linear feedback shift register (LFSR) could be rewritten as h(x)=x^{k}b(x)+b(x)+1, where x^{k}b(x) and b(x) have no terms in common but b(x), then a linear feedback shift register could be set up using the feedback: f(x)=x^{k}b(x)−x^{k}+1. Note that the symbol “−” indicates a top-tap connection back to the first stage, whereas the symbol “+” indicates a bottom-tap connection to the next stage. Similarly, if a characteristic polynomial can be rewritten as h(x)=xⁿ+x^{k}b(x)+b(x), then a linear feedback shift register can be constructed using the feedback: f(x)=xⁿ−x^{n-k}+b(x). Again, the symbols “−” and “+” are used to indicate respective tap connections. In both cases, a hybrid linear feedback shift register combining both external-XOR and internal-XOR logic within the same register is formed which reduces the number of XOR gates.

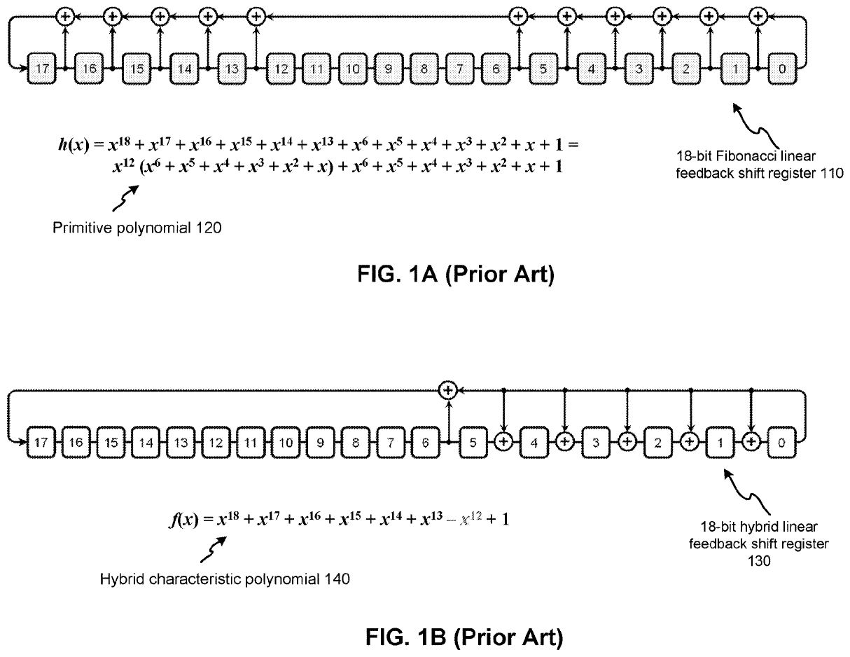

FIG. 1A illustrates an 18-bit Fibonacci linear feedback shift register 110 and a corresponding primitive polynomial 120. The primitive polynomial 120, h(x)=x¹⁸+x¹⁷+x¹⁶+x¹⁵+x¹⁴+x¹³+x⁶+x⁵+x⁴+x³+x²+x+1, can cause the 18-bit Fibonacci linear feedback shift register 110 to go through all possible 2¹⁸−1 nonzero values before entering the seed state. The primitive polynomial 120 can be rewritten as h(x)=x¹²b(x)+b(x)+1, where b(x)=x⁶+x⁵+x⁴+x³+x²+x. Thus the 18-bit Fibonacci linear feedback shift register 110 can be replaced by a hybrid linear feedback shift register having a characteristic polynomial, f(x)=x¹²b(x)−x¹²+1. FIG. 1B illustrates such an 18-bit hybrid linear feedback shift register 130 and its associated hybrid characteristic polynomial 140, f(x)=x¹⁸+x¹⁷+x¹⁶+x¹⁵+x¹⁴+x¹³−x¹²+1. The 18-bit hybrid linear feedback shift register 130 corresponds to the primitive polynomial 120 and thus can go through all possible 2¹⁸−1 nonzero values before entering the seed state like the 18-bit Fibonacci linear feedback shift register 110. The 18-bit hybrid linear feedback shift register 130, however, has only six XOR gates compared to eleven XOR gates for the 18-bit Fibonacci linear feedback shift register 110. The reduction of the XOR gate count is 1.83 times.

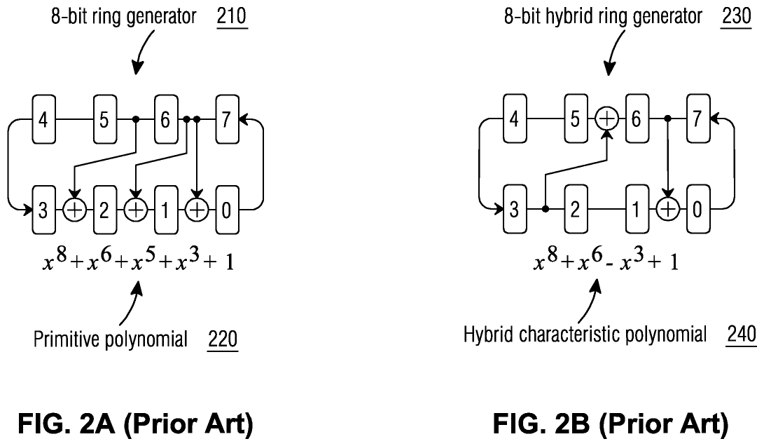

In 2011, L.-T. Wang et al. showed in the Wang paper and the '299 patent that if a given linear feedback shift register can be converted into a hybrid one, then the same can be done with the corresponding ring generator. FIG. 2A illustrates an 8-bit ring generator 210 and a corresponding primitive polynomial 220. The 8-bit ring generator 210 has three XOR gates for feedback. The primitive polynomial 220 has five terms, h(x)=x⁸+x⁶+x⁵+x³+1, which causes the 8-bit ring generator 210 to go through all possible 2⁸−1 nonzero values before entering the seed state. For a ring generator, a given feedback loop, corresponding to tap x^{k}, is created by encompassing k adjacent flip-flops, beginning with the leftmost ones. In FIG. 2A, the first feedback loop, corresponding to the feedback tap x³, is created by encompassing three adjacent flip-flops 3-5; the second feedback loop, corresponding to the feedback tap x⁵, is created by encompassing five adjacent flip-flops 2-6; and the last feedback loop, corresponding to the feedback tap x⁶, is created by encompassing six adjacent flip-flops 1-6.

The primitive polynomial 220 can be rewritten as h(x)=x³b(x)+b(x)+1, where b(x)=x⁵+x³. Thus the 8-bit ring generator 210 can be converted into a hybrid ring generator having a characteristic polynomial, f(x)=x³b(x)−x³+1. FIG. 2B illustrates such an 8-bit hybrid ring generator 230 and its associated hybrid characteristic polynomial 240, f(x)=x⁸+x⁶−x³+1. The 8-bit hybrid ring generator 230 has two XOR gates compared to three XOR gates for the 8-bit ring generator 210. The reduction of the XOR gate count is 1.50 times. Moreover, the 8-bit hybrid ring generator 230 corresponds to the primitive polynomial 220 and thus can also go through all possible 28-1 nonzero values before entering the seed state like the 8-bit ring generator 210. Due to this property, the hybrid ring generator is also referred to as a maximal-length hybrid ring generator.

A hybrid ring generator derived using the above method requires only (g+1)/2 two-input XOR gates where g is the number of 2-input XOR gates employed by the corresponding conventional ring generator. In the example illustrated in FIGS. 2A-B, the 8-bit ring generator 210 employs g=3 XOR gates, thus the hybrid ring generator 330 should employ (g+1)/2=2 XOR gates. The reduction of the XOR gate count is 3/2=1.5 times. With the number g increasing, the XOR gate count reduction ratio can become large until reaching approach 2. The Wang paper offers a list of primitive pentanomials of degree up to 800 that can be employed to derive hybrid ring generators having two 2-input XOR gates. No primitive polynomials have been reported yet with more than 5 terms that meet the requirements h(x)=x^{k}b(x)+b(x)+1 or h(x)=xⁿ+x^{k} b(x)+b(x).

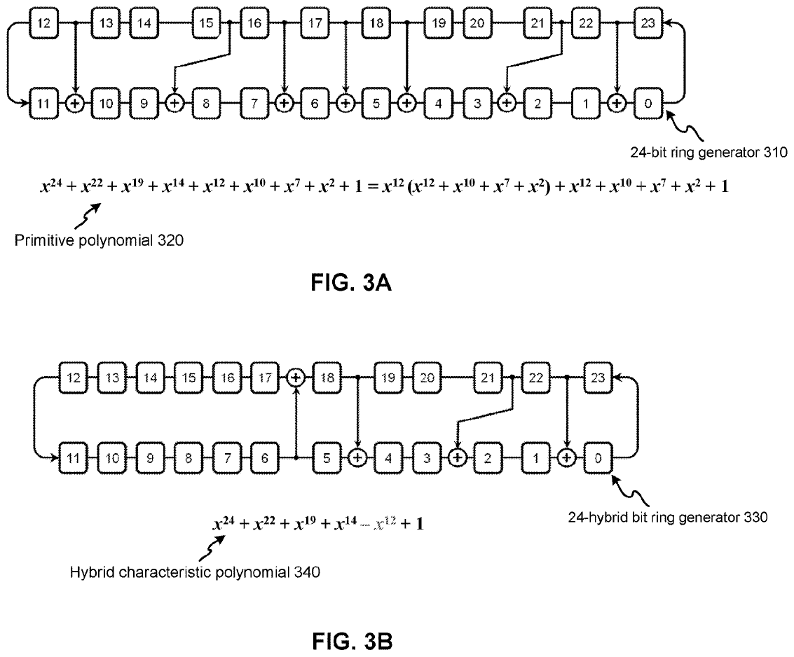

FIG. 3A illustrates a 24-bit ring generator 310 and a corresponding primitive polynomial 320. The 24-bit ring generator 310 has seven XOR gates for feedback. The primitive polynomial 320 has nine terms, h(x)=x²⁴+x²+x¹⁹+x¹⁴+x¹²+x¹⁰+x⁷+x²+1, which causes the 24-bit ring generator 310 to go through all possible 2²⁴−1 nonzero values before entering the seed state. The primitive polynomial 320 can be rewritten as h(x)=x¹²b(x)+b(x)+1, where b(x)=x¹²+x¹⁰+x⁷+x². Thus the 24-bit ring generator 310 can be converted into a hybrid ring generator having a characteristic polynomial, f(x)=x¹²b(x)−x¹²+1. FIG. 3B illustrates such a 24-bit hybrid ring generator 330 and its associated hybrid characteristic polynomial 340, f(x)=x²⁴+x²²+x¹⁹+x¹⁴−x¹²+1. The 24-bit hybrid ring generator 330 has four XOR gates and thus the reduction of the XOR gate count is 1.75 times. The 24-bit hybrid ring generator 330 is a maximal-length hybrid ring generator since it corresponds to the primitive polynomial 320.

No matter how many terms the corresponding primitive polynomial has, the hybrid ring generator derived following the method described in the Wang paper or the '299 patent always has a single feedback connection going in the opposite direction than all the remaining feedback wires as illustrated in FIGS. 2B and 3B, dictated by the single term having a negative sign in the hybrid characteristic polynomial. While the XOR gate count is reduced, the performance of these hybrid ring generators is similar to that of conventional ring generators in terms of circulation speed of injected errors and programmability. A new type of hybrid ring generators that offers better performance according to various embodiments of the disclosed technology, more diversified layouts, and more area savings will be discussed below.

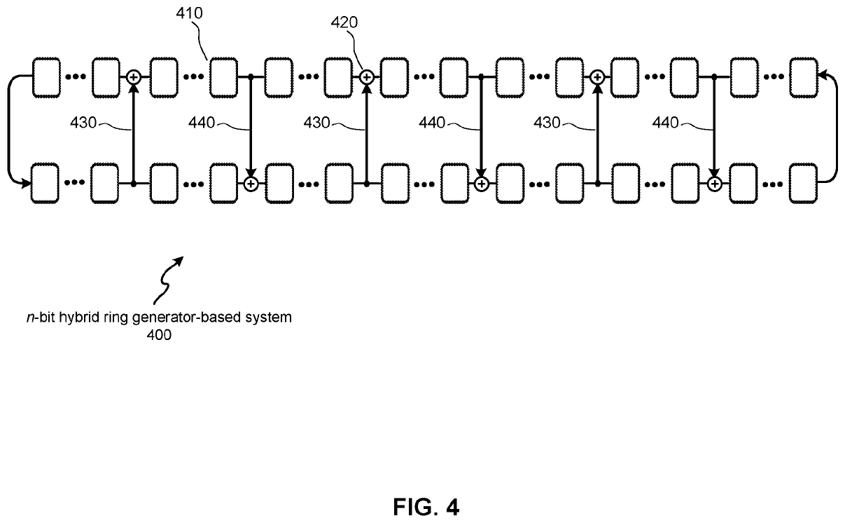

FIG. 4 illustrates an example of an n-bit hybrid ring generator-based system 400 that may be implemented according to various embodiments of the disclosed technology. The n-bit hybrid ring generator-based system 400 comprises n state elements 410 and m feedback-enable devices 420. Here, m is greater than 2. The state elements 410 can be implemented using flip-flops. The feedback-enable devices 420 can be implemented using XOR gates.

The n state elements 410 are connected directly or indirectly to each other to form a ringlike structure in a schematic diagram as illustrated in FIG. 4. An example indirect connection is connecting through one of the m feedback-enable devices 420. Another example indirect connection is connecting through an injection device (another XOR gate, for example) when the n-bit hybrid ring generator-based system 400 serves as a multiple-input test response compactor, a decompressor, or a true random number generator. The numbers of state elements placed on the top and bottom rows of the ringlike structure can be equal or differing by one.

Each of the m feedback-enable devices 420 is placed between two neighboring state elements in the n state elements 410, receiving signals directly or indirectly from one of the two neighboring state elements and a state element on a different row via one of feedback lines 430, 440, respectively. Again, an example indirect connection with one of the two neighboring state elements may be through another feedback-enable device. An example indirect connection with a state element on a different row may be through logic gate(s) when the n-bit hybrid ring generator-based system 400 is an n-bit programmable hybrid ring generator-based system which will be discussed later.

The numbers of feedback-enable devices placed on the top and bottom rows of the n-bit hybrid ring generator-based system 400 are equal or differ by one. The feedback lines 430 are associated with the feedback-enable devices on the top row and thus are referred to as upward feedback lines. The feedback lines 440 are associated with the feedback-enable devices on the bottom row and thus are referred to as downward feedback lines. The total number of feedback lines are thus equal to the number of the feedback-enable devices, m. None of the feedback lines 430, 440 cross each other. The upward feedback lines 430 and the downward feedback lines 440 are placed alternatively. While the feedback lines 430, 440 are shown as conducting lines in FIG. 4, the feedback lines 430, 440 can pass through logic gates like those used in an n-bit programmable hybrid ring generator-based system which will be discussed later.

The mutual spatial separations between the feedback lines 430, 440 may be made roughly the same so that the feedback lines 430, 440 are (approximately) uniformly distributed. For example, numbers of two groups state elements on the top row or on the bottom row between any three neighboring feedback lines or between two neighboring feedback lines and their neighboring end of the ringlike structure are equal or differ by no more than two. They are, therefore, amenable to implementing highly modular hybrid ring generators.

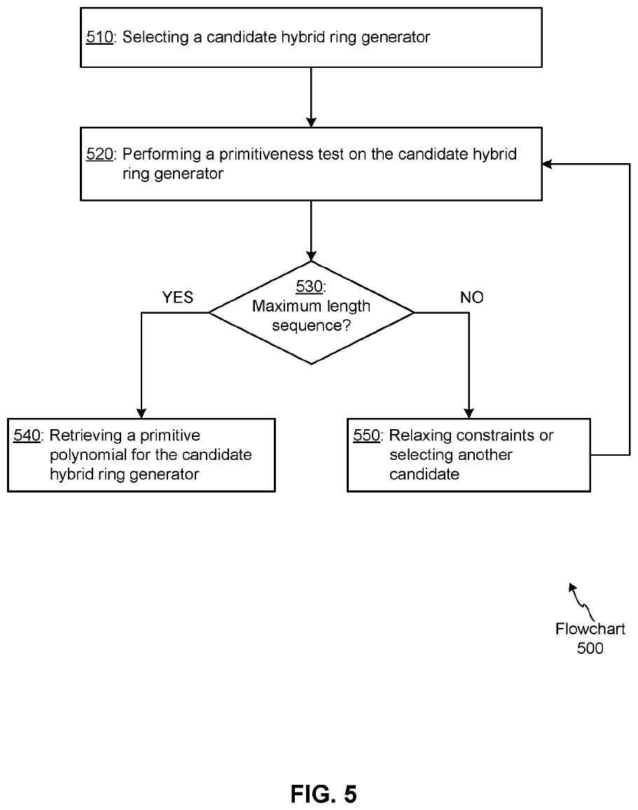

If the n-bit hybrid ring generator-based system 400 implements a primitive polynomial of degree n over Galois field of order 2, i.e., GF(2), it will yield a sequence comprising 2ⁿ−1 states, preserving the maximum length property of the corresponding linear feedback shift register (LFSR). This can be verified using a fast LFSR simulation technique. The computing time for this primitiveness test is proportional to n2, i.e., O(n²). Due to the high computational efficacy, the test can be employed to generating the n-bit hybrid ring generator-based system 400. FIG. 5 illustrates a flowchart 500 showing a process for generating a maximum-length hybrid ring generator-based system that may be implemented according to various examples of the disclosed technology. In operation 510, a candidate hybrid ring generator is selected. Its size (the number of state elements, n), the desired number of feedback taps (the number of feedback-enable devices, m), and other constraints such as feedback lines being approximately uniformly distributed can be set based on the application. The numbers of state elements in the state elements placed on the top row and the bottom row are equal or differ by one. The feedback lines of the candidate hybrid ring generator do not cross each other and the upward feedback lines and the downward feedback lines are placed alternatively.

In operation 520, a primitiveness test is performed on the candidate hybrid ring generator. The primitiveness test is based on a lemma: Suppose that 2ⁿ−1=p₁^{a}p₂^{b} . . . pₖ^{g}, where p₁, p₂, . . . pₖ are distinct primes. Then an irreducible polynomial h(x) over GF(2) is primitive if and only if x^{c}≠1 mod h(x), where c=(2ⁿ−1)/pᵢ for i=1, 2, . . . , k, wherein the ring structure implements a primitive polynomial of degree n over GF(2). The primitiveness test can analyze the corresponding n-bit LFSR implementing h(x). When initialized to a non-zero seed s, this LFSR generates a periodic sequence of span 2ⁿ−1, i.e., an m-sequence, provided that: after 2ⁿ−1 steps the seed s occurs again, and after (2ⁿ−1)/pᵢ steps the seed s does not occur again, for i=1, 2, . . . , k.

Specifically, let an n-bit LFSR be initialized with a seed having a single one on the jth position (stage) and then run for c clock cycles reaching state S[j, c]. This requires a single simulation step to determine states S[j, 1], j=0, . . . , n−1. Subsequently, values of S[j, 2ⁱ] can be derived using exclusively the principle of superposition since S[j, 2ⁱ] is equal to a bit-wise XOR of S[k, 2ⁱ⁻¹], where S[k, 2ⁱ⁻¹] is only taken into account if the kth bit of S[k, 2ⁱ⁻¹] is set to 1. Consequently, in n² steps one can obtain states S[j, 2ⁱ], i=0, . . . , n−1, j=0, . . . , n−1. By virtue of these values, any other state the LFSR reaches after a given number of cycles (like those specified above) can be computed in a similar fashion, i.e., by applying the principle of superposition in at most n steps.

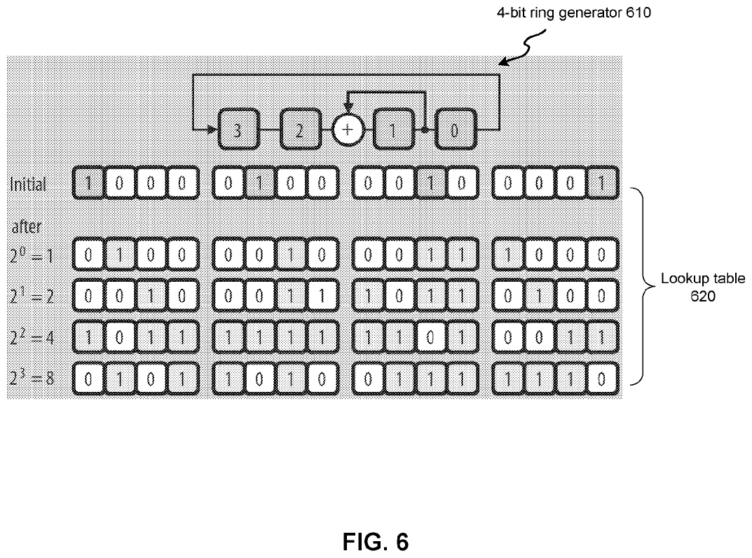

FIG. 6 illustrates a 4-bit ring generator 610 and a lookup table 620 which are used to show how the primitiveness test operates. The 4-bit ring generator 610 implements a primitive polynomial h(x)=x⁴+x+x+1. The entry located in the ith row and jth column of the lookup table 620 represents a state that the 4-bit ring generator 610 enters after 2ⁱ steps, assuming that the initial state features a single 1 on the jth position in its binary representation. Single simulation steps suffice to determine the contents of the first row of the lookup table 620. The first row entry in column j stores the state that immediately follows a state comprised of all zeros but a single 1 on position j. For instance, the 4-bit ring generator 610 initialized with state 0010 moves to state 0011 in one step, which is represented by the entry in row one, column three of the lookup table 620. The entries in the remaining rows can be determined using the principle of superposition. There is no need to use any form of logic simulation.

Assuming that its initial state was 0010, determining the state that the 4-bit ring generator 610 reaches after two clock cycles can be reduced to finding a state that the same circuit reaches after one clock cycle, provided that its current state is 0011. Superposition allows further decomposition of the problem into two simpler tasks—finding immediate successors of states 0010 and 0001—as the superposition of these states yields state 0011. As the first row of the lookup table 620 shows, the 4-bit ring generator 610 moves in one step from states 0010 and 0001 to states 0011 and 1000,respectively. Their bit-wise sum results in state 1011. This is exactly the state that should be placed in row two, column three, of the lookup table 620.

Using the lookup table 620, a state reachable after an arbitrary number of cycles in at most n basic steps, each comprising as many as n lookups. The computational complexity of this process is thus O(n²). Let the 4-bit ring generator 610 start in state 1010. The task is to determine a state that this circuit reaches after the next 11 clock cycles. Because 11=2⁰+2¹+2³, three steps are needed. An immediate (after 2⁰=1 step) successor of state 1010 can be found by determining immediate successors of states 1000 and 0010, which are, according to the lookup table 620, states 0100 and 0011, respectively. Their sum yields state 0111. Next, this state can be decomposed into three components, look up states that can be reached from them in 2¹=2 steps, and find their sum, that is, 1100. Eventually, the same approach can be applied to state 1100, this time by retrieving states reachable in 2³=8 clock cycles from states 1000 and 0100. These states are 0101 and 1010, respectively. Hence, the final state is 1111.

Referring back to FIG. 5, in operation 539, the result of the primitiveness test is checked to determine whether the candidate hybrid ring generator can generate a maximum length sequence. Specifically, whether the seed S occurs again the after 2ⁿ−1 steps and whether the seed S does not occur again, for i=1, 2, . . . , k, after (2ⁿ−1)/pᵢ steps are checked. If the answers for both questions are yes, in operation 540, a primitive polynomial is retrieved for the candidate hybrid ring generator. The Berlekamp-Massey algorithm may be employed for this operation. If the answer for either of the questions is no, in operation 550, some of the constraints may be relaxed, primarily locations of one or more feedback taps (feedback-enable devices). In some cases, another candidate hybrid ring generator with a different degree n, a different number of feedback taps, or both needs to be selected. Then the operations 520 and 530 are repeated.

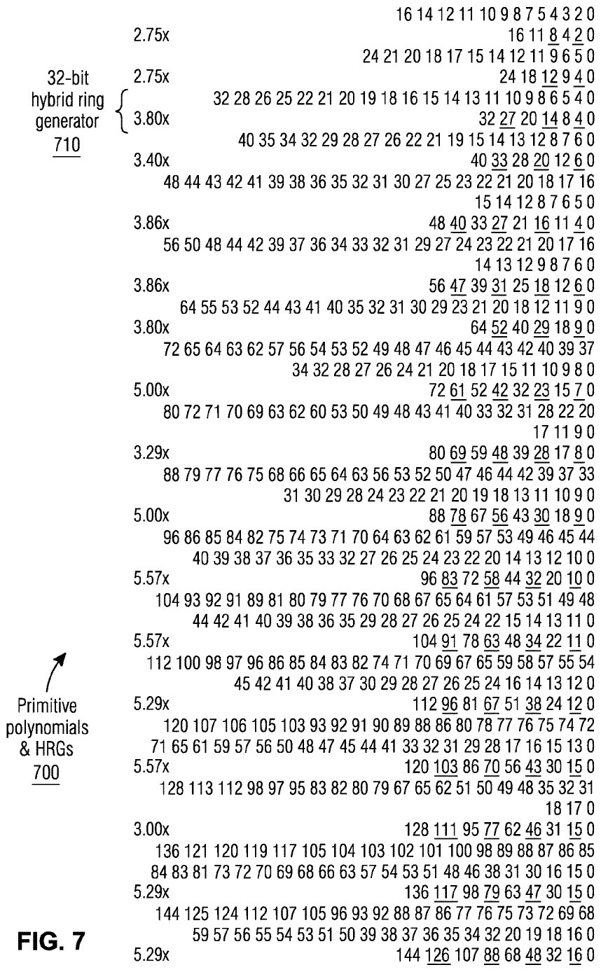

Using the structural approach illustrated by the flow chart 500, maximum-length hybrid ring generators for all degrees up to 256 have been obtained. FIG. 7 illustrates some selected results. The hybrid ring generator listed in the figure are optimal in the sense of having feedback connections (feedback lines) distributed as much uniformly as possible. They are, therefore, amenable to implementing highly modular hybrid ring generators. They feature feedback taps alternately going up and down. For each size two entries are provided: the primitive polynomial of a given degree and the corresponding hybrid ring generator. Note that only the exponents of nonzero terms are represented, so that 32 18 14 9 0 stands for x³²+x¹⁸+x¹⁴+x⁹+1. Moreover, hybrid ring generators are represented by the feedback notation where underlined numbers correspond to terms with the minus sign. For example, 32 28 24 18 12 5 0 indicates that feedback taps 5, 18, and 28 have the opposite direction (they are going up) to the remaining ones which go down. Dividing the number of polynomial terms by the number of the corresponding feedback function terms for the hybrid ring generator (with the exception of terms n and 0) gives the XOR count reduction also listed for each of the hybrid ring generators. The reduction can be as high as 7.57x, for n≤256, which is not shown in the figure.

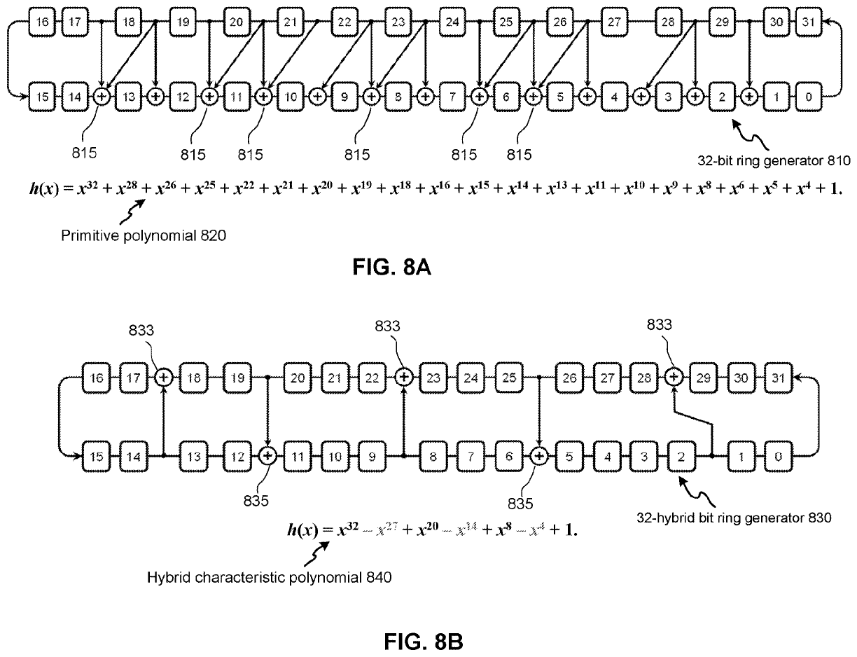

FIG. 8A illustrates an example conventional 32-bit ring generator 810 that implements a primitive polynomial 820 corresponding to a 32-bit hybrid ring generator 710 in FIG. 7. In the figure, each of the symbols 815 for the 32-bit ring generator 810 represents a pair of two-input XOR gates (feedback-enable devices) while each of the other same symbols represents a single two-input XOR gates (feedback-enable devices). In total, the 32-bit ring generator 810 has nineteen XOR gates (feedback-enable devices), corresponding to the number of the corresponding feedback function terms in primitive polynomial 820 except terms 32 and 0).

FIG. 8B illustrates an example 32-bit hybrid ring generator 820 and its hybrid characteristic polynomial 840 corresponding to the 32-bit hybrid ring generator 710 in FIG. 7. The 32-bit hybrid ring generator 820 has only five XOR gates 833, 835 as feedback-enable devices. So the reduction of feedback-enable device count is 19/5=3.8, as indicated for the 32-bit hybrid ring generator 710 in FIG. 7. The three XOR gates 833 and the two XOR gates 835 are placed alternatively on the top row and the bottom row of the 32-bit hybrid ring generator 820, respectively. As such, the upward feedback lines and the downward feedback lines not only do not cross each other but also are placed alternatively with respective to each other. Moreover, all of these upward/downward feedback lines are distributed in the ringlike structure approximately uniformly. The numbers of flip-flops between neighboring feedback lines or between a neighboring feedback line and a neighboring end of the 32-bit hybrid ring generator 820 are: 2, 2, 3, 3, 3, 3 for the top row (from left to right) and 2, 2, 3, 3, 4, 2 for the bottom row (from left to right). Thus, numbers of two groups of flip flops on the top row or on the bottom row between any three neighboring feedback lines or between two neighboring feedback lines and their neighboring end of the 32-bit hybrid ring generator 820 are equal or differ by no more than two.

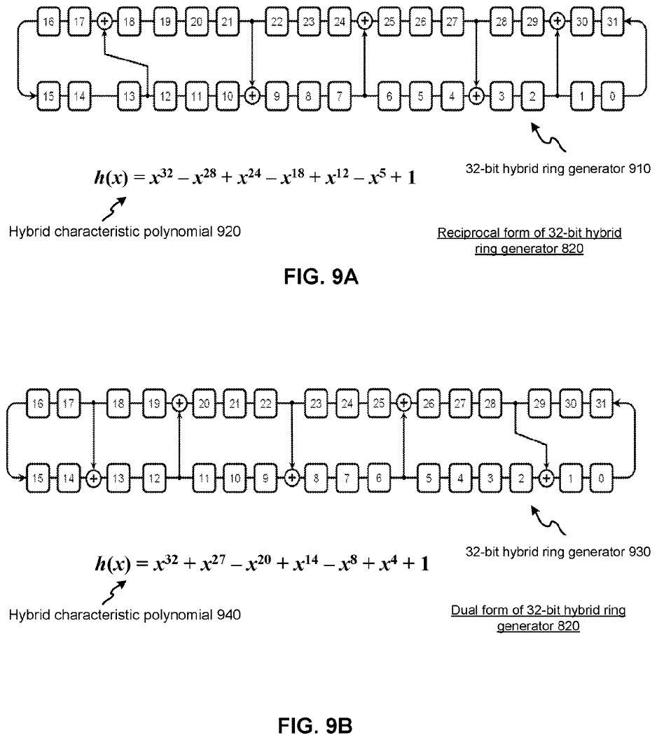

In many instances, instead of the original pseudorandom sequence produced by a ring generator or a linear feedback shift register, one may need to employ a sequence which is exactly the reverse of the original vector. Typically, this can be achieved by using a linear feedback shift register or a ring generator implementing a reciprocal polynomial h*(x) of a given polynomial h(x), where h*(x)=xⁿh(1/x). As could be expected, given an n-bit hybrid ring generator, one can easily obtain its reciprocal version by converting the feedback function of the hybrid ring generator the same way it is done for the conventional ring generators. Note that all feedback connections will maintain their original directions. FIG. 9A illustrates a 32-bit hybrid ring generator 910 and its hybrid characteristic polynomial 920 that is a reciprocal form of the hybrid characteristic polynomial 840 in FIG. 8B. As noted previously, the hybrid characteristic polynomial 840 is associated with the 32-bit hybrid ring generator 820 in FIG. 8B. Due to the reciprocity between the two hybrid characteristic polynomials 840, 920, the 32-bit hybrid ring generator 910 will generate a sequence which is the exact reversal of the sequence produced by the 32-bit hybrid ring generator 820. The reciprocal form of 32-bit hybrid ring generator 910 may be obtained by first rotating the 32-bit hybrid ring generator 820 by 180 degree on the plain and then changing the direction of each of the feedback lines. The latter can be realized by placing XOR gates on the outputs of those flip-flops that have been used to drive feedback taps in the original circuit, while the feedback lines originate now at the former locations of the respective XOR gates. The flip flops need also to be renumbered with the rightmost flip flop on the bottom row being No. 0.

Similar observations to those above apply to a process of forming dual hybrid ring generators. For a conventional ring generator, a dual form of a given ring generator can be obtained by reversing the direction of all feedback connections. Hence, a dual ring generator features XOR gates placed on the outputs of those flip-flops that have been used to drive feedback taps in the original circuit, while the feedback lines originate now at the former locations of the respective XOR gates. FIG. 9B illustrates a 32-bit hybrid ring generator 930 and its hybrid characteristic polynomial 940 that is a dual form of the hybrid characteristic polynomial 840 in FIG. 8B. Dual ring generators are instrumental in the process of phase shifter synthesis. If a given hybrid ring generator needs to drive a large number of nodes, then the corresponding phase shifter can be obtained by using a dual hybrid ring generator formed the same way it is done for the conventional ring generators. Assuming an initial state of a dual hybrid ring generator with a single logic 1, the state of the dual hybrid ring generator after q clock cycles is of interest as locations of logic 1s in this vector identify the outputs of the original hybrid ring generator to be added modulo 2 to produce a sequence spaced q shifts up a reference, i.e., a sequence originating from a stage pointed out by the logic 1 in the initial state of the dual circuit.

A multiple-input signature register (MISR) is one of the most straightforward applications of hybrid ring generators. The transient behavior of the aliasing error probability depends on architectural details of a compactor, and it can be shortened by proper selection of how injected test data circulate within a multiple-input signature register. This internal circulation can be accelerated in many cases when a hybrid ring generator, rather than a conventional ring generator, is used to implement a multiple-input signature register.

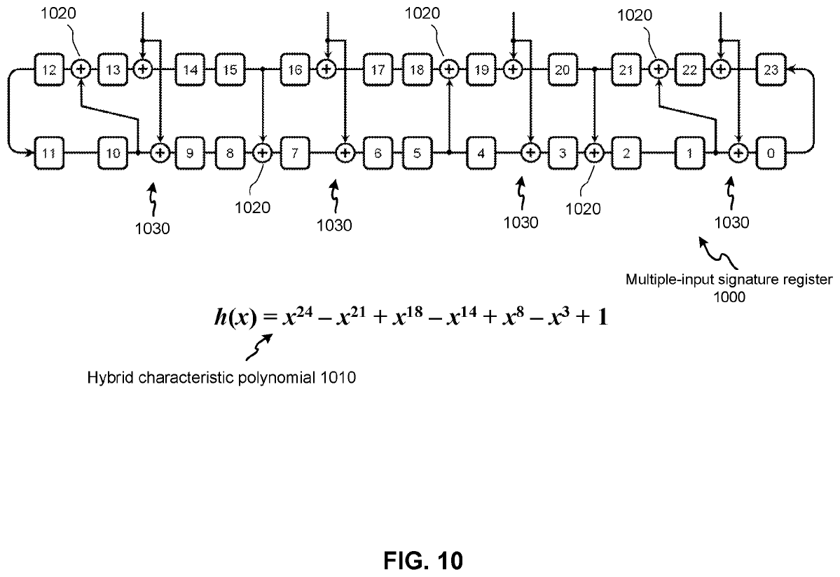

FIG. 10 illustrates an example multiple-input signature register 1000 that may be implemented according to various embodiments of the disclosed technology. The multiple-input signature register 1000 is constructed using a maximal length 24-bit hybrid ring generator associated with a hybrid characteristic polynomial 1010. In addition to five feedback-enable devices 1020, the multiple-input signature register 1000 has four pairs of injection devices 1030. Both of the feedback-enable devices 1020 and the injection devices 1030 can be implemented using two-input XOR gates. The four pairs of injection devices 1030 are coupled to four input channels, respectively.

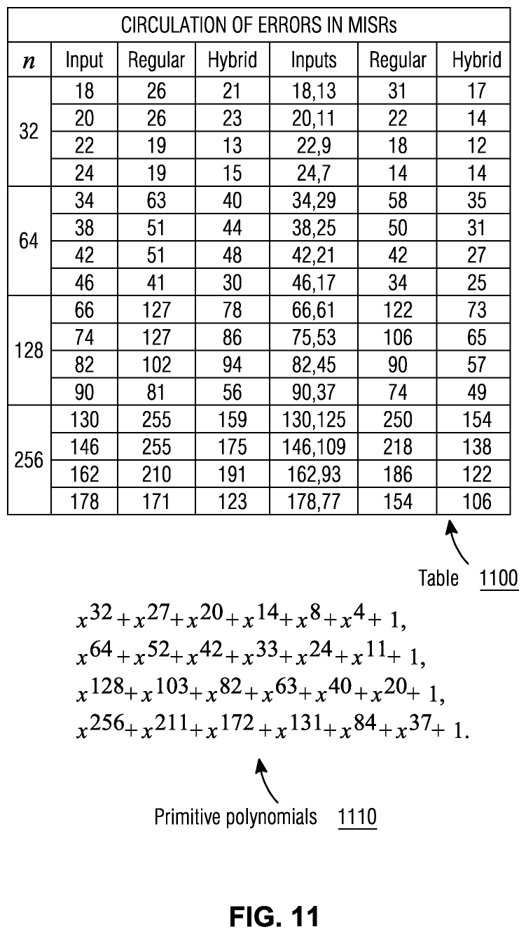

If a single error is injected through one of those input channels only, then one can easily track its circulation within the multiple-input signature register 1000 by reconstructing a part of its state trajectory beginning with a state having a single or two 1s occurring on the injection sites. A number of clock cycles τ necessary for the error to reach every flip-flop at least once can be regarded as a circulation speed measure (note that several instances of the same error may cancel each other in the course of this process). FIG. 11 illustrates a table 1100 that provides the value of τ for several multiple-input signature registers and different error injection sites. The table 1100 contrasts hybrid ring generator-based multiple-input signature registers with multiple-input signature registers constructed by means of regular ring generators whose architecture in each case matches a distribution of feedback taps of the corresponding multiple-input signature registers (except their directions). The advantage of using hybrid ring generator-based multiple-input signature registers is pronounced in each test case as they offer smaller values of metric τ than those based on conventional ring generators. For example, in a 256-bit multiple-input signature register using a regular ring generator, it takes 171 cycles for an error injected into a flip-flop 178 to reach every memory element at least once. On the contrary, an error with the same injection pattern needs only 123 cycles to be seen at every flip-flop in a hybrid ring generator-based multiple-input signature register. FIG. 11 also shows primitive characteristic polynomials 1110 for maximal length ring generators used for the table 1100. Note that for those conventional ring generators, corresponding maximal length hybrid ring generators are derived with such feedback functions that their taps are identical with those of the conventional rings but have different directions for alternative terms. For example, a conventional ring generator implementing x³²+x²⁷+x²⁰+x¹⁴+x⁸+x⁴+1 corresponds to a hybrid ring generator being associated with x³²−x²⁷+x²⁰−x¹⁴+x⁸−x⁴+1.

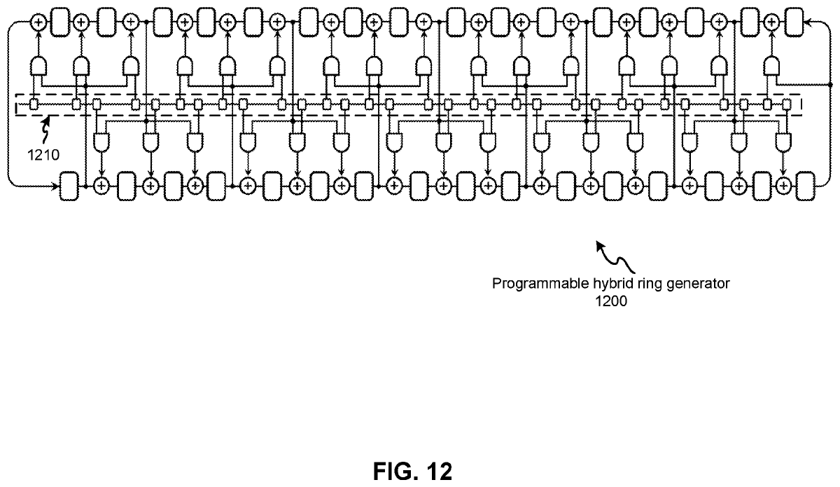

Another means of employing hybrid ring generators is to implement programmable linear feedback shift registers. A multiple-polynomial test data decompressor may serve here as an example. However, devices capable of working with thousands of primitive polynomials are especially suited to the design of cryptographic and security circuits. FIG. 12 illustrates an example programmable hybrid ring generator 1200 that may be implemented according to various embodiments of the disclosed technology. A conventional ring generator can be configured so that it allows one to pick any primitive polynomial. However, this solution, in addition to n AND gates, requires two XOR gates interspersed between every two successive flip-flops of a lower section of the ring generator, thus slowing down the entire device. Two 2-input XOR gates in a row could be replaced with a faster 3-input XOR gate, but this would be done at a price of a 30% higher transistor count. Therefore, the solution outlined in FIG. 12 offers a good trade-off between the area overhead, speed, and the number of available polynomials.

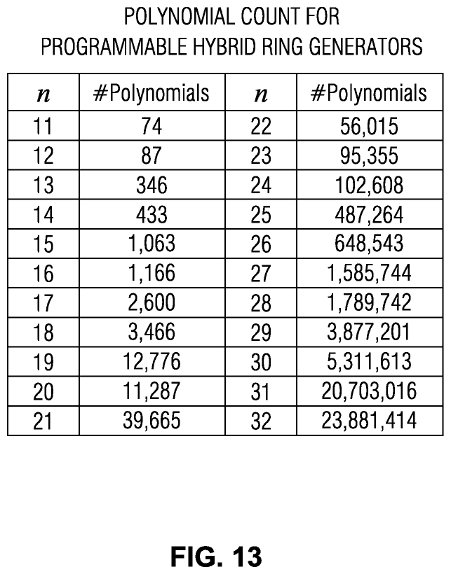

As can be seen in the figure, XOR logic introduces a single-gate delay (the actual speed of the circuit is also determined by the AND gates, as in other solutions of this kind). An n-bit selection mask register 1210 allows one to shift-in a selection mask that determines the current feedback polynomial when this unit is in operation. Although the n-bit selection mask register 1210 may enable any of 2ⁿ−1 feedback configurations, only a fraction of them corresponds to primitive polynomials. FIG. 13 illustrates the number of primitive polynomials that can be used in conjunction with hybrid ring generators similar to the programmable hybrid ring generator 1200 for n=11, 12, . . . , 32. These numbers were obtained by systematically setting all 2ⁿ−1 feedback nets and running the primitiveness test. Clearly, programmable hybrid ring generators of sizes common to many applications offer a multimillion-polynomial programming capability.

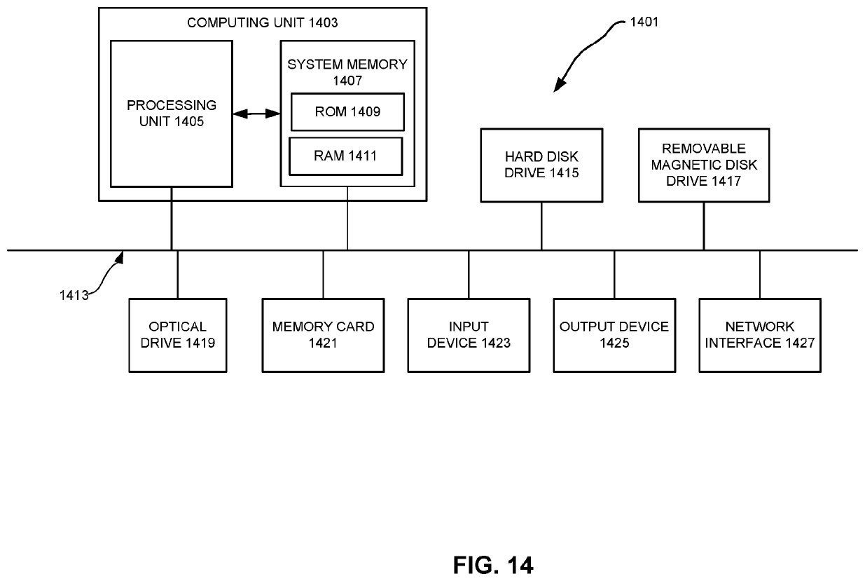

Various examples of the disclosed technology may be implemented through the execution of software instructions by a computing device, such as a programmable computer. Accordingly, FIG. 14 shows an illustrative example of a computing device 1401. As seen in this figure, the computing device 1401 includes a computing unit 1403 with a processing unit 1405 and a system memory 1407. The processing unit 1405 may be any type of programmable electronic device for executing software instructions, but it will conventionally be a microprocessor. The system memory 1407 may include both a read-only memory (ROM) 1409 and a random access memory (RAM) 1411. As will be appreciated by those of ordinary skill in the art, both the read-only memory (ROM) 1409 and the random access memory (RAM) 1411 may store software instructions for execution by the processing unit 1405.

The processing unit 1405 and the system memory 1407 are connected, either directly or indirectly, through a bus 1413 or alternate communication structure, to one or more peripheral devices. For example, the processing unit 1405 or the system memory 1407 may be directly or indirectly connected to one or more additional memory storage devices, such as a “hard” magnetic disk drive 1415, a removable magnetic disk drive 1417, an optical disk drive 1419, or a flash memory card 1421. The processing unit 1405 and the system memory 1407 also may be directly or indirectly connected to one or more input devices 1423 and one or more output devices 1425. The input devices 1423 may include, for example, a keyboard, a pointing device (such as a mouse, touchpad, stylus, trackball, or joystick), a scanner, a camera, and a microphone. The output devices 1425 may include, for example, a monitor display, a printer and speakers. With various examples of the computing device 1401, one or more of the peripheral devices 1415-1425 may be internally housed with the computing unit 1403. Alternately, one or more of the peripheral devices 1415-1425 may be external to the housing for the computing unit 1403 and connected to the bus 1413 through, for example, a Universal Serial Bus (USB) connection.

With some implementations, the computing unit 1403 may be directly or indirectly connected to one or more network interfaces 1427 for communicating with other devices making up a network. The network interface 1427 translates data and control signals from the computing unit 1403 into network messages according to one or more communication protocols, such as the transmission control protocol (TCP) and the Internet protocol (IP). Also, the network interface 1427 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 1401 is illustrated as an example only, and it is not intended to be limiting. Various embodiments of the disclosed technology may be implemented using one or more computing devices that include the components of the computing device 1401 illustrated in FIG. 14, which include only a subset of the components illustrated in FIG. 14, or which include an alternate combination of components, including components that are not shown in FIG. 14. For example, various embodiments of the disclosed technology may be implemented using a multi-processor computer, a plurality of single and/or multiprocessor computers arranged into a network, or some combination of both.

### CONCLUSION

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

What is claimed is:

1. An n-bit hybrid ring generator-based system, comprising:
n state elements connected directly or indirectly to each other to form a ringlike structure in a schematic diagram, the ringlike structure having a top row and a bottom row, numbers of state elements in the n state elements placed on the top row and the bottom row being equal or differing by one; and
m feedback-enable devices, m being greater than 2, each of the m feedback-enable devices being placed between two neighboring state elements in the n state elements and receiving signals directly or indirectly from one of the two neighboring state elements and a state element on a different row via a feedback line, respectively, numbers of feedback-enable devices placed on the top row and the bottom row being equal or differing by one, feedback lines associated with the feedback-enable devices on the top row and the bottom row being referred to as upward feedback lines and downward feedback lines, respectively,
wherein none of the m feedback lines cross each other and the upward feedback lines and the downward feedback lines are placed alternatively with respective to each other, and
wherein the ring structure implements a primitive polynomial of degree n.

2. The n-bit hybrid ring generator-based system recited in claim 1, wherein the n state elements are n flip-flops and the m feedback-enable devices are m XOR gates.

3. The n-bit hybrid ring generator-based system recited in claim 1, wherein the m feedback lines are distributed in the ringlike structure approximately uniformly, approximately uniformly meaning that numbers of two groups of state elements on the top row or on the bottom row between any three neighboring feedback lines or between two neighboring feedback lines and their neighboring end of the ringlike structure are equal or differ by no more than two.

4. The n-bit hybrid ring generator-based system recited in claim 1, further comprising:
extra feedback-enable devices;
storage devices; and
logic devices,
wherein the extra feedback-enable devices, the storage devices and the logic devices are configured to make the ring structure reconfigurable based on data bits stored in the storage devices, capable of implementing more than one primitive polynomial of degree n.

5. The n-bit hybrid ring generator-based system recited in claim 1, further comprising:
injection devices placed in the ring structure to form a multiple-input signature register.

6. The n-bit hybrid ring generator-based system recited in claim 1, wherein the numbers n, m, positions of one or more of the m feedback-enable devices, or any combinations thereof are determined based on a primitiveness test.

7. The n-bit hybrid ring generator-based system recited in claim 1, wherein the ring structure is used to derive a second ring structure implementing a reciprocal of the primitive polynomial of degree n.

8. The n-bit hybrid ring generator-based system recited in claim 1, wherein the ring structure is used to derive a dual form of the ring structure.

9. One or more computer-readable media storing computer-executable instructions for causing a computer to perform a method, the method comprising:
creating an n-bit hybrid ring generator-based system in a circuit design, the n-bit hybrid ring generator-based system comprising:
n state elements connected directly or indirectly to each other to form a ringlike structure in a schematic diagram, the ringlike structure having a top row and a bottom row, numbers of state elements in the n state elements placed on the top row and the bottom row being equal or differing by one; and
m feedback-enable devices, m being greater than 2, each of the m feedback-enable devices being placed between two neighboring state elements in the n state elements and receiving signals directly or indirectly from one of the two neighboring state elements and a state element on a different row via a feedback line, respectively, numbers of feedback-enable devices placed on the top row and the bottom row being equal or differing by one, feedback lines associated with the feedback-enable devices on the top row and the bottom row being referred to as upward feedback lines and downward feedback lines, respectively,
wherein none of the m feedback lines cross each other and the upward feedback lines and the downward feedback lines are placed alternatively with respective to each other, and
wherein the ring structure implements a primitive polynomial of degree n.

10. The one or more computer-readable media recited in claim 9, wherein the n state elements are n flip-flops and the m feedback-enable devices are m XOR gates.

11. The one or more computer-readable media recited in claim 9, wherein the m feedback lines are distributed in the ringlike structure approximately uniformly, approximately uniformly meaning that numbers of two groups of state elements on the top row or on the bottom row between any three neighboring feedback lines or between two neighboring feedback lines and their neighboring end of the ringlike structure are equal or differ by no more than two.

12. The one or more computer-readable media recited in claim 9, wherein the n-bit hybrid ring generator-based system further comprises:
extra feedback-enable devices;
storage devices; and
logic devices,
wherein the extra feedback-enable devices, the storage devices and the logic devices are configured to make the ring structure reconfigurable based on data bits stored in the storage devices, capable of implementing more than one primitive polynomial of degree n.

13. The one or more computer-readable media recited in claim 9, wherein the n-bit hybrid ring generator-based system further comprises:
injection devices placed in the ring structure to form a multiple-input signature register.

14. The one or more computer-readable media recited in claim 9, wherein the numbers n, m, positions of one or more of the m feedback-enable devices, or any combinations thereof are determined based on a primitiveness test.

15. The one or more computer-readable media recited in claim 9, wherein the ring structure is used to derive a second ring structure implementing a reciprocal of the primitive polynomial of degree n.

16. The one or more computer-readable media recited in claim 9, wherein the ring structure is used to derive a dual form of the ring structure.
